(19) United States
(12) Patent Application Publication
(10) Pub. No.: US 2008/0311276 A1
(43) Pub. Date: Dec. 18, 2008

(54) Production of Glucosinolates from Agricultural By-Products & Waste

(75) Inventors: Leslie George West, Winnetka, IL (US); Theresa Pomerleau, Buffalo Grove, IL (US); Nathan V. Matusheski, Gurnee, IL (US); Cathy Jean Ludwig, Grayslake, IL (US); Jamie Hestekin, Fayetteville, AR (US); Colin Crowley, Wheeling, IL (US); Nam-Cheol Kim, Deerfield, IL (US)

Correspondence Address: FITCH EVEN TABIN & FLANNERY, 120 S. LASALLE STREET, SUITE 1600, CHICAGO, IL, 60603-3406, US

(73) Assignee: KRAFT FOODS HOLDINGS, INC., Northfield, IL (US)

(21) Appl. No.: 11/761,883

(22) Filed: Jun. 12, 2007

(51) Int. Cl. A23L 1/28

(52) U.S. Cl. 426/655

(57) ABSTRACT

The present invention relates to a process for producing glucosinolates, particularly glucoraphanin, from cruciferous plants. More particularly, a method is provided for producing glucosinolates from agricultural by-products and waste. The general method comprises providing a mixture of glucosinolate-containing plant material and liquid, heating the mixture to inactivate enzymes in the plant material, contacting the heat inactivated mixture with an anion exchange membrane whereby at least a portion of the glucosinolates are extracted from the liquid and absorbed onto the anion exchange membrane, and releasing the glucosinolates from the anion exchange membrane. Preferably, the extraction and release steps are repeated at least once. The glucosinolates produce by the method of the invention may be incorporated into a variety of food products, pharmaceuticals, and health supplements.

The present invention relates to a process for producing glucosinolates, particularly glucoraphanin, from agricultural by-products and waste. Glucosinolates are chemoprotective precursor compounds. The glucosinolates produced by the method of the invention may be incorporated into a variety of food products, pharmaceuticals, health supplements, and related products.

### BACKGROUND

It is generally agreed that diet plays a large role in controlling the risk of developing cancers and that increased consumption of fruits and vegetables may reduce cancer incidences in humans. The presence of certain minor chemical components in plants may provide major protection mechanisms when delivered to mammalian cells. Moreover, providing pharmaceuticals, nutritional supplements, or foods fortified or supplemented with cancer-fighting chemical components derived from plants may provide additional health benefits. An important trend in the U.S. food industry is to promote health conscious food products.

Glucosinolates (β-thioglucoside-N-hydroxysulfates) are found in dicotyledenous plants and many plants of the order Capparales. Glucosinolates are found in the Brasicaceae, Resedaceae, and Capparaceae families but most commonly in the Brassicaceae family. Over one hundred glucosinolates have been characterized. Glucosinolates are sulfur-containing, water-soluble, anionic compounds of the general structure:

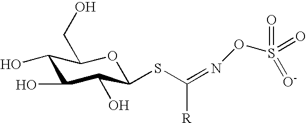

Glucosinolates include an R-group derived from amino acids and a thioglucosidic link to the carbon of a sulphonated oxime. The sulfate group imparts strongly acidic properties to glucosinolates.

Certain glucosinolates, particularly glucoraphanin (also known as sulforaphane glucosinolate or 4-methylsulfinylbutyl glucosinolate), are phytochemical precursors to potent chemoprotectants, such as sulforaphane. Glucosinolates and beta-thioglucosidase enzymes co-exist in glucosinolate-containing plants but are physically segregated until the cellular structure of the plant material is disrupted, such as by chewing, cutting, crushing, freeze-thawing, thermal treatment, or the like. Upon disruption of the cellular structure, the thioglucosidic bonds of the glucosinolates are hydrolyzed by beta-thioglucosidases, particularly myrosinase, into unstable glucosinolate aglycones, which undergo spontaneous rearrangement into potent chemoprotectants called isothiocyanates and other compounds. Isothiocyanates are biologically active and have high chemical reactivity. Isothiocyanates, particularly sulforaphane, appear to trigger carcinogen detoxification mechanisms when delivered to mammalian cells.

In addition to reducing the risk of certain cancers, glucoraphanin, through its bioactive conversion product sulforaphane, has recently been shown effective in destroying organisms responsible for causing stomach ulcers and may provide novel approaches for reducing the risk of developing cardiovascular and ocular diseases. Efforts are being undertaken to gain approval for making label claims on food products either naturally high in these agents or for foods containing added crucifer chemoprotectants. Products containing chemoprotectant additives, although without such label claims, are already on the market.

The production of glucosinolates, particularly glucoraphanin, is problematic because of their high cost. Generally, the best source of glucoraphanin has been expensive specialty broccoli cultivars. The considerable health potential of glucosinolates has not been realized due to the high cost of sourcing glucoraphanin.

Prior attempts have been made to obtain glucosinolates from plant materials. For example, ion-exchange columns and high-performance liquid chromatography (HPLC) have been used to isolate various glucosinolates. Bjerg, B. and Sørensen, H., Isolation of Intact Glucosinolates by Column Chromatography and Determination of Their Purity, in GLUCOSINOLATES IN RAPESEEDS: ANALYTICAL ASPECTS 59-75 (J-P. Wathelet ed., 1987). Fahey, J., et al., “The chemical diversity and distribution of glucosinolates and isothiocyanates among plants,” Phytochemistry, 56: 5-51 (2001). Processes such as these cannot tolerate crude samples and require glucosinolate extracts that are clarified by filtration or centrifugation before processing in the columns.

Therefore, there remains a need for a more cost-effective process, which is efficient for obtaining glucosinolates, particularly glucoraphanin, from relatively crude starting materials. The present invention fulfills these, as well as other needs, as will be apparent from the following description of embodiments of the present invention.

### SUMMARY

The present invention is directed to a cost-effective process for obtaining glucosinolates, particularly glucoraphanin, from agricultural by-products and waste. Post-harvest and discarded plant materials, including non-saleable plant materials, make effective and inexpensive starting materials for the process of the invention.

The present method represents a significant advancement over methods recently presented in U.S. patent application Ser. No. 11/199,752, filed Aug. 9, 2005, Ser. No. 11/617,934, filed Dec. 29, 2006, and Ser. No. 11/761,843 (Docket 77481), filed Jun. 12, 2007, also owned by the same assignee of the present invention.

Cruciferous vegetables have been identified as a good source of chemoprotectant precursor phytochemicals. Cruciferous vegetables include, but are not limited to, broccoli, kale, collard, curly kale, marrowstem kale, thousand head kale, Chinese kale, cauliflower, Portuguese kale, brussel sprouts, kohlrabi, Jersey kale, Chinese broccoli, rutabaga, mustard, daikon, horseradish, cabbage, savoy cabbage, Chinese cabbage, napa cabbage, broccoli rabe, arugula, watercress, cress, turnip, borecole, radish, and the like. In a preferred aspect, broccoli plant materials are utilized.

Generally, when post-harvest plant materials are used in the method of the invention, the plant materials should be processed relatively quickly after harvesting. The plant materials may be chopped or cut but should not be crushed or puréed until immediately before use in the process of the invention in order to minimize damage to cellular structures. After the plant materials are cut or otherwise damaged during harvesting, the cell wall structures of the plant materials breaks down, thus bringing glucosinolates into contact with the enzymes that convert glucosinolates into isothiocyanates. Therefore, damage to the glucosinolate-containing plant materials should be minimized prior to utilizing the plant materials in the method of the invention. In order to prolong the period of time the plant materials can be used post-harvest without deleterious impact on glucosinolate content, the glucosinolate-containing plant materials can be preserved by any conventional means, such as by freezing or drying, such as by air drying, freeze drying, vacuum drying, drum drying, spray drying, or the like. Generally, however, it is preferred that the plant material be used as soon as possible after harvesting.

Surprisingly, the process of the invention is effective for relatively crude starting materials. For example, the plant materials do not need to be washed or filtered to remove soil or other debris before use. The method of the invention generally comprises (1) providing a mixture of glucosinolate-containing plant material and liquid, (2) heating the mixture to inactivate enzymes in the plant material, (3) contacting the heat inactivated mixture with an anion exchange membrane whereby at least a portion of the glucosinolates are absorbed onto the anion exchange membrane, and (4) releasing the glucosinolates from the anion exchange membrane. The method may further comprise removing salt from the extracted glucosinolates.

In another aspect of the invention, the method comprises the following steps: (1) providing a mixture of glucosinolate-containing plant material and liquid; (2) heating the mixture to inactivate enzymes in the plant material; (3) contacting the heat inactivated mixture with an anion exchange membrane whereby at least a portion of the glucosinolates are absorbed onto the anion exchange membrane; (4) releasing the glucosinolates from the anion exchange membrane; (5) contacting the heat inactivated mixture with an anion exchange membrane whereby at least a portion of the glucosinolates are absorbed onto the anion exchange membrane; and (6) releasing the glucosinolates form the anion exchange membrane. The method may further comprise removing salt from the extracted glucosinolates.

Generally, different types of glucosinolates will bind to the membrane and the choice of plant material will dictate the final composition. Therefore, it is desirable to select plant materials containing higher levels of the glucosinolate desired to be extracted. Preferably, plant materials containing glucoraphenin or glucoraphanin are selected. More preferably, plant materials containing glucoraphanin are selected.

In another aspect, the glucosinolate extract produced by the method of the invention may be incorporated into food products, pharmaceuticals, and health supplements. The glucosinolate extract may be incorporated directly into food products or dried, cooled, frozen, or freeze-dried and then incorporated into the food products. Food product into which the glucosinolate extract may be incorporated include food supplements, drinks, shakes, baked goods, teas, soups, cereals, pills, tablets, salads, sandwiches, granolas, salad dressings, sauces, coffee, cheeses, yogurts, energy bars, and the like as well as mixtures thereof. Supplements include dietary supplements, nutritional supplements, herbal supplements, and the like. In this aspect, the food product may contain an effective amount of the glucosinolate extract, such as about 1 to about 100 mg per single serving of the food product. An effective amount of the glucosinolate extract may also be incorporated into pharmaceutical compositions, such as about 1 to about 100 mg per single dosage.

### BRIEF DESCRIPTION OF THE DRAWINGS

FIG. 1 provides the principal reactions for conversion of glucoraphanin to sulforaphane.

FIG. 2 provides a flowchart illustrating one embodiment of the process of the invention.

FIG. 3 provides a flowchart illustrating another embodiment of the process of the invention.

### DETAILED DESCRIPTION

The present process is both technically straightforward and attractive from a production cost standpoint. Indeed, the present process makes it possible to obtain glucosinolates from agricultural by-products and waste, particularly post-harvest glucosinolate-containing plants and discarded materials that would otherwise be discarded or plowed under in the fields, such as non-saleable produce, leaves, stems, seeds, and the like. The glucosinolates, particularly glucoraphanin, obtained from the process of the invention offer the health benefits of glucosinolates prepared from substantially more expensive processes.

As used herein, “chemoprotectants” and “chemoprotective compounds” refer to agents of plant origin that are effective for reducing the susceptibility of mammals to the toxic and neoplastic effects of carcinogens. Chemoprotectant “precursors” refer to agents which give rise to chemoprotectants by enzymatic and/or chemical means. Talalay, P. et al., J. Nutr., 131 (11 Supp.): 30275-30335 (2001). Examples of such chemoprotectant precursors include alkyl glucosinolates, such as glucoraphanin.

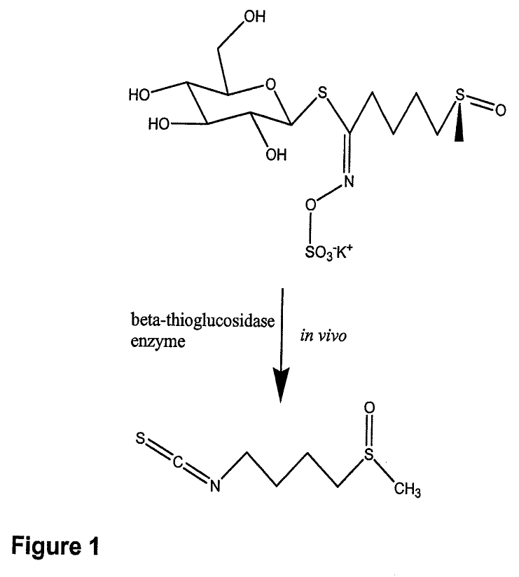

The thioglucosidic bonds of glucoraphanin are hydrolyzed in vivo by gut microflora into unstable glucosinolate aglycones, which undergo spontaneous rearrangement into isothiocyanates, such as sulforaphane, and other compounds, such as nitriles and thiocyanates. The conversion can also be catalyzed by beta-thioglucosidases, particularly myrosinase, which are found in glucosinolate-containing plants. The principal reactions are illustrated in FIG. 1.

As used herein, “effective amount” is an amount of additive which provides the desired effect or benefit upon consumption. Generally, about 1 to about 100 mg of the glucosinolates of the invention, particularly glucoraphanin, per single serving of the food product or about 1 to about 100 mg per single dosage of a pharmaceutical composition; higher amounts can be used if desired.

The term “plant materials” generally includes whole plants, leaves, plant tissue, sprouts, stems, seeds, florets, fruits, flowers, tubers, roots, the like, and mixtures thereof. While the amount of glucosinolates may vary from one part of the plant to another, from one type of plant to another, and may depend on the age of the plant, any combination of plant materials can be used so as to reduce the amount of sorting and preparation time prior to using the plant materials in the process of the invention although it is preferable to utilize the plant materials that contain desirable levels of the glucosinolates desired to be extracted.

Cruciferous vegetables have been identified as a good source of chemoprotectant precursor phytochemicals. Cruciferous vegetables include, but are not limited to, broccoli, kale, collard, curly kale, marrowstem kale, thousand head kale, Chinese kale, cauliflower, Portuguese kale, brussel sprouts, kohlrabi, Jersey kale, Chinese broccoli, rutabaga, mustard, daikon, horseradish, cabbage, savoy cabbage, Chinese cabbage, napa cabbage, broccoli rabe, arugula, watercress, cress, turnip, borecole, radish, and the like.

In a preferred aspect, broccoli plant materials are utilized. Particularly useful broccoli cultivars that may be used in the claimed method are Saga, DeCicco, Everest, Emerald City, Packman, Corvet, Dandy, Early, Emperor, Mariner, Green Comet, Green Valiant, Arcadia, Calabrese Caravel, Chancellor, Citation, Cruiser, Early Purple Sprouting Red Arrow, Eureka, Excelsior, Galleon, Ginga , Goliath, Green Duke, Greenblet, Italian Sprouting, Late Purple Sprouting, Late Winter Sprouting, White Star, Legend, Leprechaun, Marathon, Mariner, Minaret (Romanesco), Paragon, Patriot, Premium Crop, Rapine (Spring Raab), Rosalind, Salade (Fall Raab), Samurai, Shogun, Sprinter, Sultan, Taiko, Trixie, San Miguel, Arcadia, Gypsy, Everest, Patron, Southern Comet, Green Comet, Destiny, Climax and Pirate. However, many other broccoli cultivars are suitable.

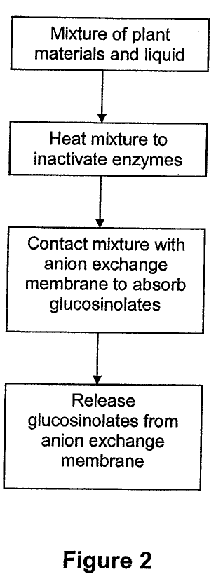

One embodiment of the present invention is illustrated in FIG. 2. The invention can be carried out in batch, semi-batch, semi-continuous, or continuous mode. The method of the invention generally comprises (1) providing a mixture of glucosinolate-containing plant material and liquid, (2) heating the mixture to inactivate enzymes in the plant material, (3) contacting the heat inactivated mixture with an anion exchange membrane whereby at least a portion of the glucosinolates are absorbed onto the anion exchange membrane, and (4) releasing the glucosinolates from the anion exchange membrane. The method may further comprise removing salt from the extracted glucosinolates.

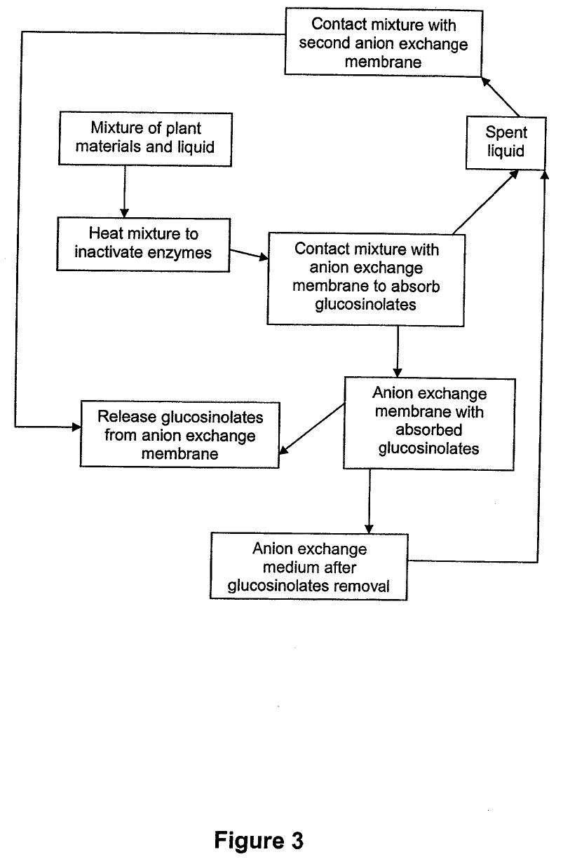

Another embodiment of the present invention is illustrated in FIG. 3. This method includes the following steps: (1) providing a mixture of glucosinolate-containing plant material and liquid; (2) heating the mixture to inactivate enzymes in the plant material; (3) contacting the heat inactivated mixture with an anion exchange membrane whereby at least a portion of the glucosinolates are absorbed onto the anion exchange membrane; (4) releasing the glucosinolates from the anion exchange membrane; (5) contacting the heat inactivated mixture with an anion exchange membrane whereby at least a portion of the glucosinolates are absorbed onto the anion exchange membrane; and (6) releasing the glucosinolates form the anion exchange membrane. The method may further comprise removing salt from the extracted glucosinolates.

While the method of the invention is suitable for agricultural by-products and waste plant materials, the plant materials should be relatively fresh and not show spoilage. Advantageously, the process of the invention is suitable for extremely crude samples, which is not commonly found in traditional processes for extracting glucosinolates from plant materials. Generally, the method of the invention does not require that the plant materials undergo any sort of purifying pretreatment (e.g., the plant materials do not need to be washed, filtered, centrifuged, or the like to remove soil, debris, or other insoluble components before use).

Generally, when post-harvest plant materials are used in the method of the invention, the plant materials should be processed by the method of the invention relatively quickly after harvesting, such as within a few hours. Glucosinolates remain intact in the plant materials until contacted by beta-thioglucosidase enzymes. The cell walls of the plant materials begin to break down post-harvest due to cellular senescence. Cellular breakdown brings the glucosinolates into contact with the enzymes, such as myrosinase, that convert glucosinolates into isothiocyanates. In order to prolong the period of time the plant materials can be used post-harvest, it may be desirable to preserve the glucosinolate-containing plant materials, such as by freezing, or drying, such as by air drying, freeze drying, vacuum drying, oven drying, or the like. Preserving the glucosinolate-containing plant materials serves to reduce the amount of conversion of glucosinolates to isothiocyanates by beta-thioglucosidases in the plant material as well as to reduce the activity of spoilage microorganisms. Generally, however, it is preferred that the materials be used soon after harvesting.

In another important aspect, damage to the glucosinolate-containing plant materials should be minimized until immediately before use in the method of the invention (i.e., within a few hours). Damage to the plant materials, such as by chewing, crushing, or cutting, also triggers the conversion of glucosinolates to isothiocyanates by beta-thioglucoisdases. Therefore, damage to the glucosinolate-containing plant materials should be minimized prior to utilizing the plant materials in the method of the invention.

Immediately prior to use in the method of the invention, such as about 1 to about 2 hours before use, the glucosinolate-containing plant materials should be treated to disrupt the cellular structure in order to facilitate the release of glucosinolates. Suitable treatment steps include, but are not limited to, pulverizing, crushing, chopping, puréeing, the like, or a combination thereof. If the plant materials include seeds, the seeds can be pulverized and defatted prior to use. In one aspect, the seeds may be defatted using known defatting procedures, such as described in West, L., J. Agric. Food Chem., 52: 916-926 (2004), which is incorporated herein by reference.

The plant materials should then be heated for a time and temperature sufficient to inactivate enzymes in the glucosinolate-containing plant material. Generally, the plant materials are heated to about 60° C. to about 110° C. for at least about five minutes. The heat treatment may be by any conventional means, such as by boiling, steaming, microwaving. Preferably, the heat treatment step inactivates beta-thioglucosidase enzymes, preferably myrosinase, present in the plant materials in order to prevent the conversion of glucosinolates to isothiocyanates. Advantageously, the heat treatment also inactivates microbes in the mixture. It has also been found that the heat treatment improves the extraction of glucosinolates from the plant materials by increasing solubility and increasing water penetration into the plant materials. Generally, if boiling is used as the heat treatment, the amount of liquid is not critical as long as there is sufficient liquid to thoroughly and evenly heat the plant materials.

Depending on the method of heating selected, it may be necessary to increase the volume of liquid in the mixture following the heat treatment step. Generally, the liquid is water but may be water containing an organic solvent, such as ethyl alcohol. Preferably, the liquid is water. The amount of liquid in the mixture should be sufficient to make a stirrable slurry.

The heat inactivated mixture is then contacted with an anion exchange membrane to extract glucosinolates from the heat inactivated mixture. Preferably, the anion exchange membrane is a strong base type membrane but weak base membranes may be used, if desired. Depending on the type of membrane selected, the membrane may require pre-treatment, such as soaking to “swell” the membrane. Preferably, the anion exchange membrane is formed as a sheet and is immersed in the heat inactivated mixture. It is generally preferred to circulate the heat inactivated mixture during the extraction step, such as by stirring, mixing, or agitating by any convenient means. Generally, the anion exchange membrane should contact the heat inactivated mixture for about 4 to about 24 hours to allow glucosinolates to absorb to the anion exchange membrane. The temperature during extraction should be sufficiently low as to decrease the risk of microbial outgrowth during the extraction step, such as at a temperature of about 2 to about 7° C. Suitable anion exchange membranes include strongly basic membranes, such as Electropure Excellion anion exchange membrane I 200 from Snowpure, LLC in San Clemente, Calif. The surface of the membrane has “locked in place” groups having a positive charge and an appropriate counter ion, such as chloride. Glucosinolates have a stronger negative charge and take the place of the chloride ion, thus binding the glucosinolates to the membrane.

Once the glucosinolates have been absorbed to the membrane, it is preferable to wash the anion exchange membrane with de-ionized water to remove debris. The anion exchange membrane having bound glucosinolates is then contacted with an aqueous liquid containing salts, such as KCl, NaCl, or other food-grade inorganic salts, to facilitate the release of bound glucosinolates from the anion exchange membrane into the aqueous liquid. Preferably, the aqueous liquid contains 1 M KCl. Generally, the amount of liquid is not critical as long as there is sufficient liquid to cover the membrane. Generally, about 4 to about 5 hours is sufficient time to release the glucosinolates from the membrane. Generally, at least about 80 percent of the glucosinolates are removed from the membrane. Again, the temperature should be sufficiently low as to reduce the risk of microbial outgrowth during the release step, such as a temperature of about 2 to about 7° C.

Generally it is preferred to repeat the extraction and release steps at least once to maximize the amount of glucosinolates removed from the heat inactivated mixture. Preferably, the same anion exchange membrane used in the previous extraction and release steps is used although a new anion exchange membrane may be used if desired.

The glucosinolates released into the aqueous liquid may be further treated if desired. Preferably, the aqueous medium containing the glucosinolates is treated to remove salt. Salt is removed because salt is generally undesired in the final product. Generally, salt can be removed from the aqueous medium by any conventional technique including, for example, dialyzing against deionized water using one or more cellulose ester membrane. Preferably, salt is removed by dialyzing against de-ionized water for about 12 to about 24 hours at about 2 to about 7° C. using one or more 100 molecular weight cutoff (MWCO) cellulose ester membranes.

The glucosinolates released into the aqueous liquid may be further processed into a variety of forms, if desired. For example, the glucosinolates may be dried, such as by spray drying, freeze drying, vacuum drying, or the like, to form a dried glucosinolate extract. Generally, the resulting extract can then be dried for a time sufficient to reduce the water content of the extract to less than about 10 percent, preferably to less than about 5 percent, to form a dried glucosinolate extract. Generally, the extract may be dried using any known method, such as, but not limited to, freeze drying, spray drying, vacuum drying, and the like.

The glucosinolate extract may also be further processed by cooling or freezing, or may be subjected to membrane processing, chromatographic processing, or dialysis to remove unwanted anionic substances that were bound to and were released from the anion exchange membrane, such as to form a glucosinolate isolate or purified product.

The glucosinolate extract may also have introduced optional ingredients or components, such as, for example, flavorants, nutrients, vitamins, colorants, nutraceutical additives, antioxidants, probiotics, and the like, so long as the optional ingredients do not adversely affect the stability in a significant manner. In particular, the presence and amount of such optional ingredients can, of course, vary considerably depending on the product in which the extract is incorporated.

The glucosinolate extract may be included in a variety of products, including food products and pharmaceuticals. The glucosinolate extract may also be used as a food fortificant. Food product into which the glucosinolate extract may be incorporated include food supplements, drinks, shakes, baked goods, teas, soups, cereals, pills, tablets, salads, sandwiches, granolas, salad dressings, sauces, coffee, cheeses, yogurts, energy bars, and the like as well as mixtures thereof. Supplements include dietary supplements, nutritional supplements, herbal supplements, or the like. In this aspect, the food product may contain an effective amount of glucosinolate extract, such as about 1 to about 100 mg per single serving of the food product. An effective amount of the glucosinolate extract may also be incorporated into pharmaceutical compositions, such as about 1 to about 100 mg. Of course, higher amounts can be included if desired.

Following the process of the invention, the spent plant materials used in the invention may be recycled and used as feed material for animals. Generally, the spent plant material can be separated from the aqueous liquid by filtration, centrifugation, decanting, or the like, to provide plant materials suitable for animal feed. The spent plant materials are uniquely useful as feed material because the materials no longer contain glucosinolates. It is generally desired that plant materials used for animal feed have low levels of glucosinolates because glucosinolate-containing plant materials have been found to have undesired effects on animals when used as a primary food source.

The following examples are intended to illustrate the invention and not to limit it. Unless otherwise stated, all percentages, parts, and ratios are by weight. All references (including publications, patents, patent applications, patent publications, and the like) cited in the present specification are hereby incorporated by reference.

### EXAMPLES

### Example 1

### Glucosinolates from Broccoli Seeds

Fifteen grams of broccoli seeds were defatted by hexane extraction and pulverized to pass through a #18 seive. The pulverized and defatted broccoli seeds were added to 1500 ml of de-ionized water to form a mixture. The mixture was boiled for 5 minutes to inactivate the beta-thioglucosidase enzymes in the seeds. The total volume of the mixture was then brought to 4500 ml with de-ionized water. One square foot of Electropure Excellion anion exchange membrane heterogeneous strong base, Type 1, Model I-200 (Snowpure, LLC in San Clemente, Calif.), was suspended in the continuously stirred mixture held at 5° C. for 24 hours. After extraction, the anion exchange membrane was briefly washed with deionized water and the membrane was placed in a stirred tank containing 4500 ml of 1 N KCl at 5° C. for 4 hours to release the glucosinolates from the anion exchange membrane. The glucoraphanin concentration of the aqueous medium was measured by HPLC. Extraction over 24 hours resulted in 58 percent removal of total available glucoraphanin. 1 N KCl released essentially all bound glucoraphanin in 4 hours.

To maximize the yield of glucosinolates, both the extraction and release steps are repeated. The same anion exchange membrane was returned to the extraction tank for an additional 18 hours. The anion exchange membrane was then returned to the same 1 N KCl tank for four hours. The total removal of glucoraphanin was increased to 81 percent by repeating the process as described. A 4 hour treatment in the same 1 N KCl tank again released essentially all of the bound glucoraphanin.

Following the extraction and release steps, salt was removed by dialyzing against de-ionized water overnight at 5° C. using 100 molecular weight cutoff (MWCO) cellulose ester membranes.

### Example 2

### Glucosinolates from Broccoli Florets

The process of Example 1 was repeated using 150 g dried and pulverized broccoli florets. The broccoli florets were pulverized to pass through a #18 sieve. The process resulted in greater than 80 percent recovery of glucosinolates.

### Example 3

### Glucosinolates from Plants

The process of Example 1 was repeated using 1 kg freshly harvested broccoli leaves and stems. The broccoli leaves and stems were steamed to inactivate the beta-thioglucosidase enzymes for 20 minutes. The broccoli leaves and stems were then puréed. The process resulted in recovery of glucosinolates similar to that of Example 1.

While the invention has been described in terms of preferred embodiments, those skilled in the art will recognize that the invention can be practiced with modification within the spirit and scope of the appended claims.

What is claimed is:

1. A method of extracting glucosinolates from glucosinolate-containing plant material, said method comprising:
(i) providing a mixture of glucosinolate-containing plant material and liquid;
(ii) heating the mixture for a time and temperature sufficient to inactivate enzymes in the glucosinolate-containing plant material to form a heat inactivated mixture;
(iii) contacting the heat inactivated mixture with an anion exchange membrane for about 4 to about 24 hours and a temperature of about 2 to about 7° C., whereby at least a portion of the glucosinolates are absorbed onto the anion exchange membrane; and
(iv) contacting the anion exchange membrane having absorbed glucosinolates with an aqueous solution for a time sufficient to release the extracted glucosinolates from the anion exchange membrane to form an aqueous media containing the glucosinolates.

2. The method of claim 1 wherein the glucosinolate-containing plant material is selected from the group consisting of broccoli, kale, collard, curly kale, marrowstem kale, thousand head kale, Chinese kale, cauliflower, Portuguese kale, brussel sprouts, kohlrabi, Jersey kale, Chinese broccoli, rutabaga, mustard, daikon, horseradish, cabbage, savoy cabbage, Chinese cabbage, napa cabbage, broccoli rabe, arugula, watercress, cress, turnip, borecole, radish, the like, and mixtures thereof.

3. The method of claim 2 wherein the glucosinolate-containing plant material comprises at least one of the group consisting of florets, seeds, leaves, sprouts, and stems.

4. The method of claim 1 further comprising pre-treating the glucosinolate-containing plant material in step (i) by at least one of the group consisting of dehydrating, defatting, freezing, pulverizing, crushing, chopping, puréeing, or a combination thereof.

5. The method of claim 1 wherein the heating step is at a temperature of about 60 to about 110° C. for about 5 to about 15 minutes.

6. The method of claim 1 wherein the extracted glucosinolates are glucoraphanin.

7. The method of claim 1 further comprising repeating steps (iii) and (iv) before step (v).

8. The method of claim 1 further comprising removing salt from the extracted glucosinolates.

9. A method of extracting glucosinolates from glucosinolate-containing plant material, said method comprising:
(i) providing a mixture of glucosinolate-containing plant material and liquid;
(ii) heating the mixture for a time and temperature sufficient to inactivate enzymes in the glucosinolate-containing plant material to form a heat inactivated mixture;
(iii) contacting the heat inactivated mixture with an anion exchange membrane for about 4 to about 24 hours and a temperature of about 2 to about 7° C., whereby at least a portion of the glucosinolates are absorbed onto the anion exchange membrane;
(iv) contacting the anion exchange membrane having absorbed glucosinolates with an aqueous solution for a time sufficient to release the extracted glucosinolates from the anion exchange membrane to form an aqueous media containing the glucosinolates;
(v) contacting the heat inactivated mixture with an anion exchange membrane for about 4 to about 24 hours at a temperature of about 2 to about 7° C., whereby at least a portion of the glucosinolates are absorbed onto the anion exchange membrane;
(vi) contacting the anion exchange membrane of step (v) having absorbed glucosinolates with an aqueous solution for a time sufficient to release the extracted glucosinolates from the anion exchange membrane to form an aqueous media containing the glucosinolates.

10. The method of claim 9 wherein the glucosinolate-containing plant material is selected from the group consisting of broccoli, kale, collard, curly kale, marrowstem kale, thousand head kale, Chinese kale, cauliflower, Portuguese kale, brussel sprouts, kohlrabi, Jersey kale, Chinese broccoli, rutabaga, mustard, daikon, horseradish, cabbage, savoy cabbage, Chinese cabbage, napa cabbage, broccoli rabe, arugula, watercress, cress, turnip, borecole, radish, the like, and mixtures thereof.

11. The method of claim 10 wherein the glucosinolate-containing plant material comprises at least one of the group consisting of florets, seeds, leaves, sprouts, and stems.

12. The method of claim 9 further comprising pre-treating the glucosinolate-containing plant material in step (i) by at least one of the group consisting of dehydrating, defatting, freezing, pulverizing, crushing, chopping, puréeing, or a combination thereof.

13. The method of claim 9 wherein the heating step is at a temperature of about 60 to about 110° C for about 5 to about 15 minutes.

14. The method of claim 9 wherein the glucosinolates are glucoraphanin.

15. A glucosinolate extract formed by a process comprising:
(i) providing a mixture of glucosinolate-containing plant material and liquid;
(ii) heating the mixture for a time and temperature sufficient to inactivate enzymes in the glucosinolate-containing plant material to form a heat inactivated mixture;
(iii) contacting the heat inactivated mixture with an anion exchange membrane for about 4 to about 24 hours and a temperature of about 2 to about 7° C., whereby at least a portion of the glucosinolates are absorbed onto the anion exchange membrane; and
(iv) contacting the anion exchange membrane having absorbed glucosinolates with an aqueous solution for a time sufficient to release the extracted glucosinolates from the anion exchange membrane to form an aqueous media containing the glucosinolates.

16. The glucosinolate extract of claim 15 wherein the glucosinolate-containing plant material is selected from the group consisting broccoli, kale, collard, curly kale, marrowstem kale, thousand head kale, Chinese kale, cauliflower, Portuguese kale, Brussels sprouts, kohlrabi, Jersey kale, savoy cabbage, collards, borecole, radish, and mixtures thereof.

17. The glucosinolate extract of claim 16 wherein the glucosinolate-containing plant material comprises at least one of the group consisting of florets, seeds, leaves, sprouts, and stems.

18. The glucosinolate extract of claim 15 wherein the process further comprises pre-treating the glucosinolate-containing plant material in step (i) by at least one of the group consisting of dehydrating, defatting, freezing, pulverizing, crushing, chopping, puréeing, or a combination thereof.

19. The glucosinolate extract of claim 15 wherein the heating step is at a temperature of about 60 to about 110° C. for about 5 to about 15 minutes.

20. The glucosinolate extract of claim 15 wherein the glucosinolates are glucoraphanin.

21. The glucosinolate extract of claim 15 wherein the process further comprises repeating steps (iii) and (iv) after step (iv).

22. The glucosinolate extract of claim 15 wherein the process further comprises removing salt from the extracted glucosinolates.

23. A food product comprising an effective amount of the glucosinolate extract of claim 15.

24. The food product of claim 23 wherein the glucosinolates are glucoraphanin.

25. A pharmaceutical composition comprising an effective amount of the glucosinolate extract of claim 15.

26. The pharmaceutical composition of claim 15, wherein the glucosinolates are glucoraphanin.
